(19) United States
(12) Patent Application Publication
(10) Pub. No.: US 2021/0288584 A1
(43) Pub. Date: Sep. 16, 2021

(54) SWITCHING POWER SUPPLY DEVICE

(71) Applicant: Yasumichi Omoto, Aichi (JP)

(72) Inventor: Yasumichi Omoto, Aichi (JP)

(73) Assignee: NIDEC MOBILITY CORPORATION, Aichi (JP)

(21) Appl. No.: 17/198,855

(22) Filed: Mar. 11, 2021

(30) Foreign Application Priority Data
Mar. 11, 2020 (JP) 2020-041669

(51) Int. Cl. H02M 3/335; H02M 3/156; H02M 1/08

(52) U.S. Cl. CPC H02M 3/33569; H02M 1/08; H02M 3/156

(57) ABSTRACT

A DC-DC converter (switching power supply device) includes: a first converter having a first switching element; a second converter having a second switching element and a transformer; and a controller that generates and outputs a first pulse signal for use in driving the first switching element and a second pulse signal for use in driving the second switching element. The controller shifts a phase of the first pulse signal from a phase of the second pulse signal by a predetermined amount so that an exciting current that flows through the transformer in response to switching operations of the first switching element and the second switching element becomes zero on average.

### CROSS-REFERENCE TO RELATED APPLICATION

This application is based on Japanese Patent Application No. 2020-41669 filed with the Japan Patent Office on Mar. 11, 2020, the entire contents of which are incorporated herein by reference.

### FIELD

The disclosure relates to a switching power supply device provided between a power supply and a load and, more particularly, to a multi-stage switching power supply device in which a plurality of converters are connected in series between its input and output.

### BACKGROUND

Switching power supply devices, such as direct current-direct current (DC-DC) converters, convert an input voltage into a predetermined voltage by switching the input voltage with switching elements. For such switching power supply devices, pulse width modulation (PWM) signals are typically used as pulse signals to drive the respective switching elements. A switching power supply device adjusts the duty of PWM signals so as to output a voltage and a current in accordance with a load. To adjust the duty of the PWM signals to a predetermined value, for example, the switching power supply device compares a detected value of the output voltage with a target value and performs feedback control in such a way that the difference between the detected value with the target value becomes zero.

Some switching power supply devices employ a two-stage type in which a first converter is provided in a front stage (on a power supply side) and a second converter is provided in a rear stage (on a load side). Such two-stage switching power supply devices are described in JP 1-255469A, JP 4-121065A, and JP 2006-288035A. Further, in some two-stage switching power supply devices, the second converter provided in the rear stage is formed as a full-bridge type of converter that includes a transformer and four switching elements that constitute a full-bridge circuit.

Full bridge type of converters, as described above, need to cope with a magnetic unsymmetrical phenomenon that may emerge in the transformer. This magnetic unsymmetrical phenomenon refers to a phenomenon in which the exciting current of the transformer is imbalanced on the positive and negative sides. When the magnetic unsymmetrical phenomenon emerges, the exciting current gradually increases. If this state is continued, the transformer is magnetically saturated, causing the exciting current to rapidly increase, in which case the switching elements may be damaged. To reduce the emergence of the magnetic unsymmetrical phenomenon, it is necessary to use a transformer that resists being magnetically saturated. However, this type of transformers may disadvantageously have a large volume.

In a conventional method of decreasing the exciting current, a resistor or a capacitor is disposed between the full-bridge circuit and the transformer. This method, however, may involve some additional components, thereby disadvantageously hindering the compactness of the device and leading to high costs.

There is another disadvantage that can arise in two-stage switching power supply devices. When the first converter and the second converter are driven at the same switching frequency, the magnetic unsymmetrical phenomenon may emerge in the transformer of the second converter, details of which will be described later. The simplest way to avoid this disadvantage is to differently set the switching frequencies of the first and second converters. In this method, the switching frequency of one converter is set to a frequency (e.g., 270 kHz) in order for this converter to avoid emitting amplitude modulation (AM) band auditory noises, which otherwise would adversely affect radio receivers. In this case, however, the switching frequency of the other converter needs to be set to a different frequency so that this converter may emit AM band auditory noises.

### SUMMARY

An object of the disclosure is to provide a switching power supply device that includes a plurality of converters connected in multiple stages and that can easily and effectively reduce the emergence of the magnetic unsymmetrical phenomenon in a transformer.

A switching power supply device according to one or more embodiments of the disclosure converts an input voltage into a predetermined voltage and then supplies the converted voltage to a load. This switching power supply device is provided between a power supply and the load. The switching power supply device includes a first converter, a second converter, and a controller. The first converter includes a first switching element configured to switch the input voltage. The second converter includes a second switching element and a transformer having a primary side through which a current switched by the second switching element flows, the second converter being provided in a next stage of the first converter. The controller is configured to generate and output a first pulse signal for use in driving the first switching element and a second pulse signal for use in driving the second switching element. The controller is configured to shift a phase of the first pulse signal from a phase of the second pulse signal by a predetermined amount so that an exciting current that flows through the transformer in response to switching operations of the first switching element and the second switching element becomes zero on average.

The above configuration allows the phase of the first pulse signal to be shifted from the phase of the second pulse signal by the predetermined amount, thereby successfully making an exciting current of the transformer balanced. Thus, even if the first pulse signal and the second pulse signal have the same frequency, the exciting current is less likely to be imbalanced.

Consequently, the configuration can reduce the emergence of the magnetic unsymmetrical phenomenon, suppressing damage to the first and second switching elements.

In one or more embodiments of the disclosure, the second switching element may include four switching element components that constitute a full-bridge circuit. The four switching element components may include two first switching element components that are paired and turned on together and two second switching element components that are paired and turned on together. The controller may calculate a difference between a first current flowing through the full-bridge circuit over a first period in which the first switching element components are paired and turned on together and a second current flowing over a second period in which the second switching element components are paired and turned on together. Then, the controller may shift the phase of the first pulse signal from the phase of the second pulse signal by the predetermined amount so that the calculated difference becomes zero.

In one or more embodiments of the disclosure, the controller may include a current difference calculator, a phase adjuster, and a signal generator. The current difference calculator may be configured to calculate the difference between the first current and the second current. The phase adjuster may be configured to adjust the phases of the first pulse signal and the second pulse signal, based on the difference calculated by the current difference calculator. The signal generator may be configured to generate the first pulse signal and the second pulse signal having a predetermined phase difference, based on an output of the phase adjuster.

In one or more embodiments of the disclosure, the controller may further include a deviation calculator and a duty adjuster. The deviation calculator may be configured to compare an output voltage of the second converter with a target value and to calculate a deviation between the output voltage and the target value. The duty adjuster may be configured to adjust duties of the first pulse signal and the second pulse signal, based on the deviation calculated by the deviation calculator. The signal generator may generate the first pulse signal and the second pulse signal having the predetermined phase difference and a predetermined duty, based on outputs of the phase adjuster and the duty adjuster.

In one or more embodiments of the disclosure, a period over which the first switching element is turned on may equally overlap the first period over which the first switching element components of the second switching element are paired and turned on together and the second period over which the second switching element components of the second switching element are paired and turned on together.

In one or more embodiments of the disclosure, the period over which the first switching element is turned on may completely contain a third period over which one of the first switching element components that are paired is turned on but the other of the first switching element components is turned off. The third period may be a period between the first period and the second period.

In one or more embodiments of the disclosure, a frequency of the first pulse signal may equate with a frequency of the second pulse signal. Alternatively, a frequency ratio of the first pulse signal to the second pulse signal may be set to an integral multiple.

In one or more embodiments of the disclosure, the first converter may be a buck converter, a boost converter, or a buck-boost converter. The second converter may be a full-bridge type direct current-direct current (DC-DC) converter.

According to one or more embodiments of the disclosure, it is possible to easily and effectively reduce the emergence of the magnetic unsymmetrical phenomenon in a transformer of a multi-stage switching power supply device.

### BRIEF DESCRIPTION OF THE DRAWINGS

FIG. 1 is a circuit diagram according to a first embodiment of the disclosure;

FIGS. 2A, 2B, and 2C are each a timing chart for use in explaining a principle in the disclosure;

FIGS. 3A and 3B are each a timing chart when the phases of PWM signals are not shifted;

FIGS. 4A and 4B are each a timing chart when the phases of PWM signals are shifted; and

FIG. 5 is a circuit diagram according to a second embodiment of the disclosure.

### DETAILED DESCRIPTION

Embodiments of the disclosure will be described with reference to the drawings. In the drawings, the identical or equivalent component is designated by the identical numeral. In embodiments of the disclosure, numerous specific details are set forth in order to provide a more through understanding of the invention. However, it will be apparent to one of ordinary skill in the art that the invention may be practiced without these specific details. In other instances, well-known features have not been described in detail to avoid obscuring the invention.

Some embodiments of the disclosure will be described with reference to the drawings. In the individual drawings, the same reference numerals are given to identical or equivalent components. Hereinafter, a two-stage DC-DC converter, which is an example of a switching power supply device, will be described.

### First Embodiment

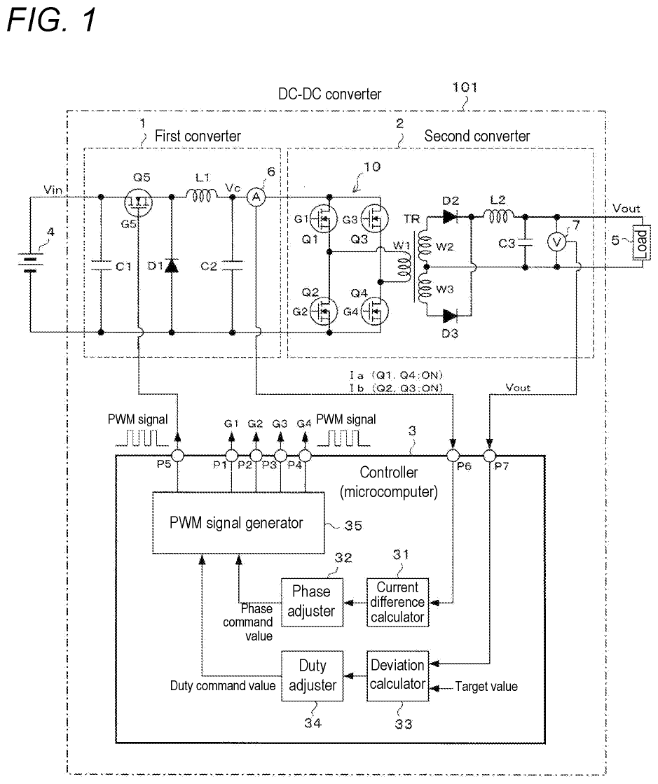

FIG. 1 illustrates a two-stage DC-DC converter (referred to below simply as a “DC-DC converter”) according to a first embodiment of the disclosure. A DC-DC converter 101 connected between a DC power supply 4 and a load 5 includes: a first converter 1 provided in a front stage (on a power supply side); a second converter 2 provided in a rear stage of the first converter 1 (on a load side); and a controller 3 that controls both the first converter 1 and the second converter 2. For example, the DC power supply 4 may be a battery mounted in a vehicle, whereas the load 5 is electric equipment, such as an audio device, an air conditioner, and a lighting device mounted in the vehicle.

The first converter 1, which is a buck converter in this example, is formed of a known circuit including a capacitor C1, a switching element Q5, a diode D1, an inductor L1, and a capacitor C2. The first converter 1 is provided with a current detector 6 that detects a current flowing through the switching elements Q1 to Q4 in the second converter 2. The switching element Q5 corresponds to a “first switching element” in one or more embodiments of the disclosure.

The switching element Q5 is formed of a field-effect transistor (FET) in this example. FIG. 1 does not illustrate a parasitic diode present between the source and drain of this FET (and also does not illustrate parasitic diodes in the switching elements Q1 to Q4 and Q6 that will be described later). The capacitor C1 is a filter capacitor that removes ripple components from an input voltage Vin of the DC power supply 4. The diode D1 is a circulation diode that conducts electricity to circulate the electric energy of the inductor L1 over a period in which the switching element Q5 is turned off. The capacitor C2 is a capacitor that supplies a voltage charged through the inductor L1 to the second converter 2.

The second converter 2, which is a full-bridge phase shift converter in this example, is formed of a known circuit that includes: the four switching elements Q1 to Q4 that constitute a full-bridge circuit 10; a transformer TR having a primary winding W1 and secondary windings W2 and W3; diodes D2 and D3 that constitute a rectifier circuit; and an inductor L2 and a capacitor C3 that constitute a smoothing circuit. The second converter 2 is provided with a voltage detector 7 that detects an output voltage Vout. Each of the switching elements Q1 to Q4 corresponds to a “second switching element” in one or more embodiments of the disclosure.

Of the four switching elements Q1 to Q4, the switching elements Q1 and Q2 are connected in series, and the switching elements Q3 and Q4 are connected in series. The node between the switching elements Q1 and Q2 is connected to a first end of the primary winding W1 in the transformer TR, whereas the node between the switching elements Q3 and Q4 is connected to a second end of the primary winding W1. This configuration forms a first current path along which a current flows from the switching element Q1 to the switching element Q4 via the primary winding W1 and a second current path along which the current flows from the switching element Q3 to the switching element Q2 via the primary winding W1. As a result, the direction in which the current flows along the primary winding W1 over the period in which both the switching elements Q1 and Q4 are turned on is opposite to the direction in which the current flows along the primary winding W1 over the period in which both the switching elements Q2 and Q3 are turned on.

Although not illustrated in FIG. 1, an exciting inductance is equivalently connected in parallel to the primary winding W1 of the transformer TR. In response to the switching operations of the switching elements Q1 to Q5, the exciting current flows through this exciting inductance. This exciting current also flows in opposite directions, depending on which of both the switching elements Q1 and Q4 and both the switching elements Q2 and Q3 are turned on. In a regular state, the exciting current is balanced on the positive and negative sides with its center being 0 A; however, if the magnetic unsymmetrical phenomenon emerges in the transformer TR, the exciting current may be imbalanced on the positive and negative sides (details of which will be described later).

When an AC voltage is generated in the primary winding W1 of the transformer TR in response to the switching operations of the switching elements Q1 to Q5, this AC voltage is transmitted to the secondary windings W2 and W3 and then rectified by the diodes D2 and D3. After the rectified voltage is smoothed by the inductor L2 and the capacitor C3, the DC voltage with reduced ripple components is supplied to the load 5.

The controller 3, which may be formed of a microcomputer in this example, includes a current difference calculator 31, a phase adjuster 32, a deviation calculator 33, a duty adjuster 34, and a PWM signal generator 35. FIG. 1 illustrates each of the current difference calculator 31, the phase adjuster 32, the deviation calculator 33, the duty adjuster 34, and the PWM signal generator 35 in a block form for the sake of convenience; however, in fact, each of the processes performed by the current difference calculator 31, the phase adjuster 32, the deviation calculator 33, the duty adjuster 34, and the PWM signal generator 35 is implemented in software. The PWM signal generator 35 corresponds to an example of the “signal generator” in one or more embodiments of the disclosure.

The input of the current difference calculator 31 is connected to a port P6 (analog to digital (A/D) conversion port) of the controller 3. The current detected by the current detector 6 is supplied to the port P6. The current difference calculator 31 calculates a difference |Ia−Ib| between currents Ia and Ib: the current Ia flows through the full-bridge circuit 10 over the period in which the two switching elements Q1 and Q4 are paired and turned on together; and the current Ib flows through the full-bridge circuit 10 over the period in which the two switching elements Q2 and Q3 are paired and turned on together. The current difference calculator 31 outputs its calculation result to the phase adjuster 32. It should be noted that the currents Ia and Ib flow through the primary winding W1 of the transformer TR in opposite directions.

Based on the current difference calculated by the current difference calculator 31, the phase adjuster 32 adjusts the phases of PWM signals for use in driving the switching element Q5 in the first converter 1 and the switching elements Q1 to Q4 of the second converter 2. Details of this phase adjustment will be described later.

The input of the deviation calculator 33 is connected to a port P7 (A/D conversion port) of the controller 3. The output voltage Vout detected by the voltage detector 7 is supplied to the port P7. Furthermore, a target value of the output voltage is supplied to the deviation calculator 33. The deviation calculator 33 compares the output voltage Vout with the target value and calculates a deviation between the output voltage Vout and the target value. Then, the deviation calculator 33 outputs its calculation result to the duty adjuster 34.

Based on the deviation calculated by the deviation calculator 33, the duty adjuster 34 adjusts the duties of the PWM signals for use in driving the switching element Q5 in the first converter 1 and the switching elements Q1 to Q4 in the second converter 2. Since the duty adjuster 34 may employ a known feedback control method to adjust the duties, details of how to adjust the duties will not be described herein.

The phase adjuster 32 outputs a phase command value to the PWM signal generator 35, whereas the duty adjuster 34 outputs a duty command value to the PWM signal generator 35. Based on these phase command value and duty command value, the PWM signal generator 35 generates PWM signals having predetermined phase differences and predetermined duties and then outputs these PWM signals to the switching element Q1 to Q5 via ports P1 to P5 (PWM output ports) of the controller 3.

More specifically, the PWM signal output via the port P5 is supplied to a gate G5 of the switching element Q5 in the first converter 1 to turn on or off the switching element Q5. The PWM signals output via the ports P1 to P4 are supplied, respectively, to the gates G1 to G4 of the switching elements Q1 to Q4 in the second converter 2 to turn on or off the switching elements Q1 to Q4. It should be noted that FIG. 1 does not illustrate the connection lines between ports P1 to P4 and gates G1 to G4 for the sake of convenience. The PWM signal output via the port P5 corresponds to an example of a “first pulse signal” in one or more embodiments of the disclosure, whereas each of the PWM signals output via the ports P1 to P4 corresponds to an example of a “second pulse signal” in one or more embodiments of the disclosure.

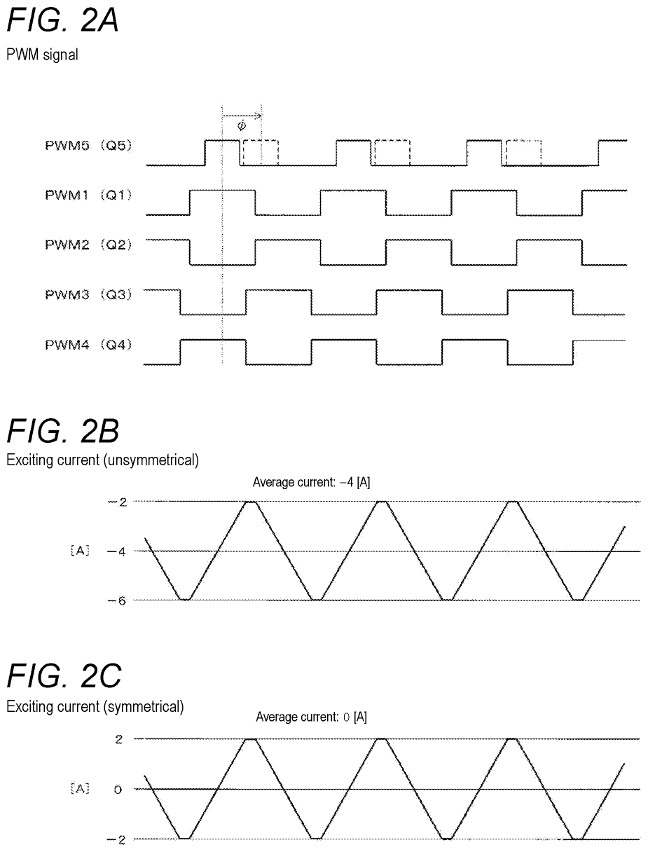

Next, a principle in one or more embodiments of the disclosure will be described with reference to FIGS. 2A to 2C. FIG. 2A illustrates the waveforms of the PWM signals output from the controller 3 via the ports P1 to P5. PWM5 denotes a PWM signal output to the switching element Q5 in the first converter 1 via the port P5, whereas PWM1 to 4 denote PWM signals output to the switching elements Q1 to Q4 in the second converter 2 via ports P1 to P4. PWM2 is a signal formed by inverting PWM1, whereas PWM4 is a signal formed by inverting PWM3. The frequency of PWM5 (or the switching frequency of the switching element Q5) is set to be the same as the frequency of PWM1 to PWM4 (or the switching frequency of switching elements Q1 to Q4).

When the switching element Q5 in the first converter 1 is driven by PWM5 represented by the solid line and the switching elements Q1 to Q4 in the second converter 2 are also driven by PWM1 to PWM4 as illustrated in FIG. 2A, the magnetic unsymmetrical phenomenon may emerge in the transformer TR to make the exciting current imbalanced, depending on the state (load amount) of the load 5. FIG. 2B illustrates an example of the waveform of the exciting current. The value of this exciting current varies from −2 A (A: ampere) on the positive side to −6 A on the negative side with its center being −4 A. Therefore, the average value of the current is −4 A, not 0 A. This means that, if 0 A is regarded as a reference, the exciting current is largely biased to the negative side and thus is imbalanced.

It is known that the magnetic unsymmetrical phenomenon tends to emerge when a conduction time of the two switching elements Q1 and Q4 that are paired and turned on together does not coincide with a conduction time of the two switching elements Q2 and Q3 that are paired and turned on together. It is believed that the reason why the conduction times do not coincide with each other is due to variations in the switching speeds of the switching elements. It is also known that, when a voltage across the primary winding W1 of the transformer TR is imbalanced on the positive and negative sides, the magnetic unsymmetrical phenomenon tends to emerge even if the conduction times coincide with each other. One or more embodiments of the disclosure are involved in the magnetic unsymmetrical phenomenon that emerges in the latter case. As already described, the emergence of the magnetic unsymmetrical phenomenon may rapidly increase the exciting current, damaging the switching elements.

In conventional art, it is difficult to compensate for an imbalanced exciting current as illustrated in FIG. 2B. This is because the phase relationship between PWM5 (solid line) and PWM1 to PWM4, as illustrated in FIG. 2A, is not changed even when the above magnetic unsymmetrical phenomenon emerges. As opposed to this, in one or more embodiments of the disclosure, the exciting current flowing through the transformer TR is monitored, and in accordance with the degree of the magnetic unsymmetrical phenomenon, the phase of PWM5 is shifted by a predetermined amount φ relative to the phases of PWM1 to PWM4, as indicated by the broken line in FIG. 2A. This phase shift amount φ is a variable and is controlled so that the exciting current is kept balanced, as will be described later. The phase shift amount φ is varied in accordance with the amount of the load 5, which the exciting current depends on. It should be noted that PWM5 (broken line) and PWM1 to PWM4 have the same frequency in one or more embodiments of the disclosure.

Shifting the phases of the PWM signals for use in driving both the first converter 1 and the second converter 2 by a predetermined amount in the above manner can compensate for the imbalanced exciting current. The reason for this will be described later. According to one or more embodiments of the disclosure, as illustrated in FIG. 2C, the exciting current flowing through the transformer TR varies from 2 A on the positive side to −2 A on the negative side with its center being 0 A. In this case, the current is 0 A on average, which means that the exciting current is balanced on the positive and negative sides. Consequently, it is possible to reduce the emergence of the magnetic unsymmetrical phenomenon in the transformer TR independently of the load amount, thereby preventing damage to the switching elements.

The phase shift amount φ illustrated in FIG. 2A is calculated by both the current difference calculator 31 and the phase adjuster 32 illustrated in FIG. 1. As described above, the current difference calculator 31 calculates the difference (ΔI=|Ia−Ib|) between the current Ia flowing through the switching elements Q1 and Q4 over the period in which both the switching elements Q1 and Q4 are turned on and the current Ib flowing through the switching elements Q2 and Q3 over the period in which both the switching elements Q2 and Q3 are turned on. Then, the phase adjuster 32 determines the phase shift amount φ so that the current difference ΔI becomes zero. Herein, zero implies “nearly zero”, which allows ΔI to fluctuate within a predetermined range (the same applies below).

The exciting current is different from each of the currents Ia and Ib flowing through the primary winding W1 of the transformer TR but is proportional to each of the currents Ia and Ib. Therefore, the fact that the current difference ΔI=|Ia−Ib| equates with 0 A means that the exciting current equates with 0 A on average, in other words, that the exciting current is balanced on the positive and negative sides. Thus, monitoring of the currents Ia and Ib is equivalent to monitoring of the exciting current of the transformer TR. Thus, adjusting the phase shift amount φ so that the exciting current is balanced at about 0 A can result in reduced emergence of the magnetic unsymmetrical phenomenon.

The reason why shifting the phases of the PWM signals for use in driving both the first converter 1 and the second converter 2 by a predetermined amount results in a balanced exciting current is considered as follows.

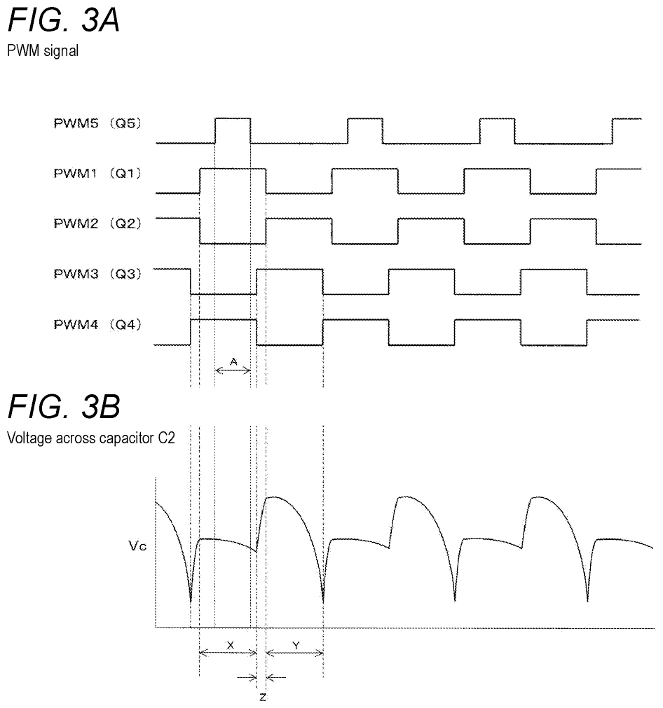

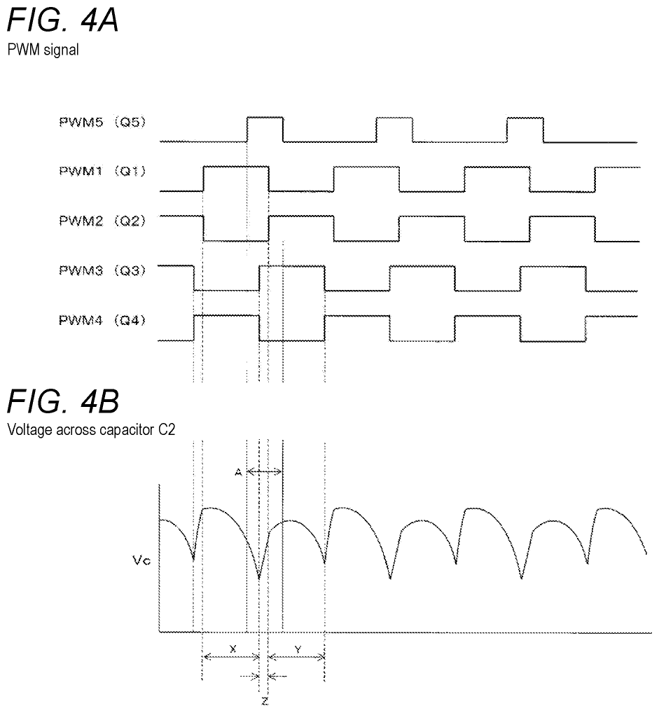

FIGS. 3A and 3B illustrate the signal waveforms when the phases of the PWM signals are not shifted: FIG. 3A illustrates the waveforms of the PWM signals; and FIG. 3B illustrates the waveform of a voltage Vc across the capacitor C2 in the first converter 1. FIGS. 4A and 4B illustrate the signal waveforms when the phases of the PWM signals are shifted: FIG. 4A illustrates the waveforms of the PWM signals; and FIG. 4B illustrates the waveform of the voltage Vc across the capacitor C2 in the first converter 1. In FIG. 4A, the waveforms of PWM1 to 4 are identical to those in FIG. 3A, but the phase of PWM5 is delayed by the above phase shift amount φ as opposed to FIG. 3A. Note that in FIGS. 3 and 4, the load 5 is expected to be heavy.

In FIGS. 3A and 3B, a period A corresponds to a time zone over which PWM5 is at H (High) level, that is, a period in which the switching element Q5 is turned on. A period X corresponds to a time zone between times when PWM1 rises and when PWM4 falls, that is, the period in which both the switching elements Q1 and Q4 are paired and turned on together. A period Y corresponds to a time zone between times when PWM2 rises and when PWM3 falls, that is, the period in which both the switching elements Q2 and Q3 are paired and turned on together. A period Z corresponds to a period between the periods X and Y, over which one of the paired switching elements Q1 and Q4 is turned on and the other is turned off and one of the paired switching elements Q2 and Q3 is turned on and the other is turned off. The periods X, Y, and Z correspond, respectively, to a “first period”, a “second period”, and a “third period” in one or more embodiments of the disclosure.

Over the period X, both the switching elements Q1 and Q4 are turned on together, causing a current to flow along the first current path in the full-bridge circuit 10 in the order of the switching element Q1, the primary winding W1 of the transformer TR, and the switching element Q4. This current transmits electric power from the primary winding W1 to the secondary windings W2 and W3 and then supplies the electric power to the load 5. Over the period A within the period X, the switching element Q5 is turned on by the PWM5, charging the capacitor C2 through the inductor L1. However, the electric charge stored in the capacitor C2 is discharged to the full-bridge circuit 10 because both the switching elements Q1 and Q4 are turned on together. As a result, over the period X, the capacitor C2 is charged and discharges, in which case the discharging amount somewhat exceeds the charging amount, thus slightly decreasing the voltage Vc across the capacitor C2.

Over the period Z coming next, one of each pair of switching elements (one of Q1 and Q4 and one of Q2 and Q3) is turned off, causing almost no current to flow through the full-bridge circuit 10. In which case, the full-bridge circuit 10 supplies no electric power to the load 5. Over the period Z, the capacitor C2 stops discharging the electric power to the full-bridge circuit 10 and is charged with the electric energy stored in the inductor L1, so that the voltage Vc across the capacitor C2 increases.

Over the next period Y coming next, both the switching elements Q2 and Q3 are turned on together, causing a current to flow along the second current path in the full-bridge circuit 10 in the order of the switching element Q3, the primary winding W1 of the transformer TR, and the switching element Q2. In this case, the current flows in the direction opposite to that in which the current flows over the period X. This current transmits electric power from the primary winding W1 to the secondary windings W2 and W3 and then supplies the electric power to the load 5. Over the period Y, the switching element Q5 is turned off and thus does not charge the capacitor C2. Thus, when both the switching elements Q2 and Q3 are turned on together, the capacitor C2 discharges the electric power to the full-bridge circuit 10 at once. As a result, over the period Y, the voltage Vc across the capacitor C2 greatly decreases.

When the phase of PWM5 is not shifted as illustrated in FIGS. 3A and 3B, the period A over which the switching element Q5 is turned on is completely contained in the period X but does not overlap the period Y. Therefore, as described above, the capacitor C2 is charged and discharged over the period X, slightly decreasing the voltage Vc across the capacitor C2, whereas the capacitor C2 rapidly discharges, greatly decreasing the voltage Vc over the period Y. As a result, the voltage Vc across the capacitor C2 is imbalanced in the periods X and Y, so that the exciting current flowing through the transformer TR based on the voltage Vc is also imbalanced.

Next, a description will be given of the case where the phase of PWM5 is shifted as illustrated in FIGS. 4A and 4B. In FIGS. 4A and 4B, the period A over which the switching element Q5 is turned on partially equally overlaps the periods X and Y. The “equally” herein implies “substantially equally” which allows for slightly differently (the same applies below). Therefore, the charge and discharge amounts of the capacitor C2 over the period X are substantially the same at those over the period Y. In FIGS. 4A and 4B, the period A over which the switching element Q5 is turned on contains the period Z (i.e., a period in which the capacitor C2 does not discharge). In shirt, the period A completely contains the period Z. Therefore, turning on the switching element Q5 can effectively charge the capacitor C2, promptly increasing the voltage Vc across the capacitor C2. As a result, in the case of FIGS. 4A and 4B, the voltage Vc across the capacitor C2 is almost balanced in the periods X and Y, so that the exciting current flowing through the transformer TR based on the voltage Vc is also balanced.

When the switching frequency of the first converter 1 is equal to (the integral multiple of) that of the second converter 2, the switching elements Q1 to Q5 always perform switching at the same timings. Thus, the voltage Vc across the capacitor C2 may be fixed in a specific imbalanced state, leading to the emergence of the magnetic unsymmetrical phenomenon. However, shifting the phases of the PWM signals in the first converter 1 and the second converter 2, as illustrated in FIGS. 4A and 4B, can compensate for the imbalance of the voltage Vc across the capacitor C2. Therefore, it is possible to reduce the emergence of the magnetic unsymmetrical phenomenon even if the switching frequency of the first converter 1 is equal to (the integral multiple of) that of the second converter 2.

The load 5 is heavy in the examples of FIGS. 3A and 3B and 4A and 4B; however, even if the load 5 is light, it is also possible to make the exciting current balanced, reducing the emergence of the demagnetization. When a light load is driven in a current discontinuity mode, however, a period in which the current flowing through the inductor L1 becomes zero appears within the period over which the switching element Q5 is turned off. In which case, it is necessary to adjust the switching timing of the switching elements Q1 to Q5 so that the charging and discharging of the capacitor C2 are balanced. Even in this case, it is also necessary to determine the phase shift amount φ of PWM5 so that the voltage Vc across the capacitor C2 is almost balanced in the periods X and Y, which is similar to the case of a heavy load.

According to the foregoing first embodiment, the phase of the PWM signal (PWM5) for use in driving the first converter 1 is shifted from the phase of the PWM signals (PWM1 to PWM4) for use in driving the second converter 2 by a predetermined amount φ so that the exciting current of the transformer TR becomes zero on average. In this way, the exciting current can be balanced. Consequently, even if the PWM signals for use in driving both the first converter 1 and the second converter 2 have the same frequency, the exciting current is not imbalanced. Consequently, it is possible to easily and effectively reduce the emergence of the magnetic unsymmetrical phenomenon in the transformer TR.

### Second Embodiment

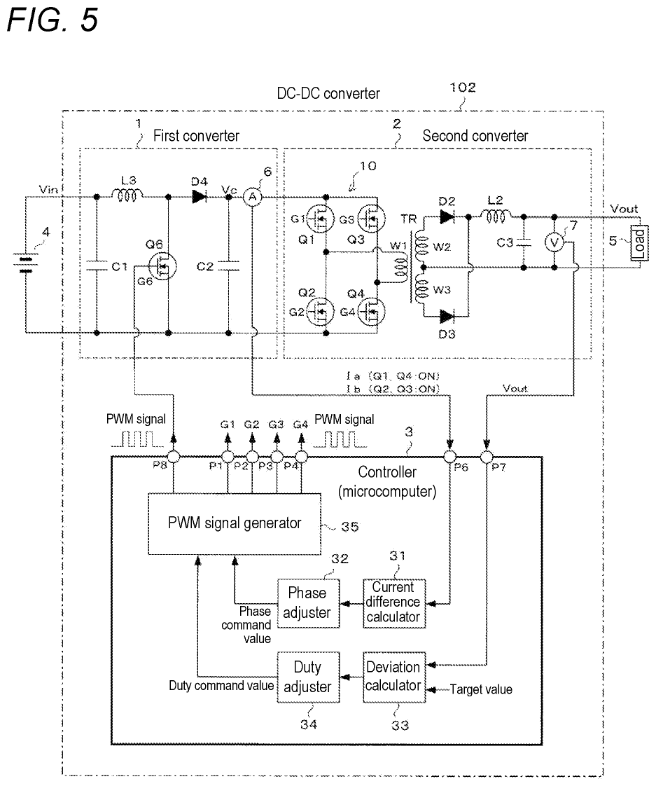

FIG. 5 illustrates a DC-DC converter 102 according to a second embodiment of the disclosure. The DC-DC converter 102 is similar to the foregoing first embodiment in including a first converter 1, a second converter 2, and a controller 3 but differs in that the first converter 1 is formed as a boost converter.

In FIG. 5, the first converter 1 is formed of a known circuit including a capacitor C1, an inductor L3, a switching element Q6, a diode D4, and a capacitor C2. The first converter 1 is provided with a current detector 6. The connection configuration of the inductor L3, the switching element Q6, and the diode D4 differs from that of the inductor L1, the switching element Q5, and the diode D1 illustrated in FIG. 1. The circuit configuration of the capacitors C1 and C2 and the current detector 6 are the same as that in FIG. 1. The switching element Q6, which is formed of an FET in this example, corresponds to the “first switching element” in one or more embodiments of the disclosure.

The switching element Q6 is connected at a gate G6 to a port P8 (PWM output port) of the controller 3. In response to a PWM signal output via the port P8, the switching element Q6 is turned on or off. The inductor L3 is formed of a boosting coil that generates a high voltage in response to a switching operation of the switching element Q6. The diode D4 is a rectifying diode that rectifies an alternating current (AC) pulse output from the switching element Q6. Other configurations are the same as those in FIG. 1, and thus details thereof will not be described below.

The above DC-DC converter 102 in the second embodiment also shifts, by a predetermined amount, a phase of a PWM signal for use in driving the switching element Q6 in the first converter 1 from a phase of PWM signals for use in driving switching elements Q1 to Q4 in the second converter 2. This can ensure the balance of an exciting current. Consequently, even if the PWM signals for use in driving both the first converter 1 and the second converter 2 have the same frequency, the exciting current is not imbalanced. It is therefore possible to easily and effectively reduce the emergence of the magnetic unsymmetrical phenomenon in a transformer TR, similarly to the foregoing first embodiment.

### Other Embodiments

The disclosure can employ various embodiments that will be described below, in addition to an illustrative embodiment.

An illustrative embodiment exemplifies a two-stage switching power supply device (DC-DC converter) in which a first converter 1 is connected in series to a second converter 2. However, the disclosure may employ a switching power supply device in which three or more converters are connected in series.

An illustrative embodiment exemplifies a first converter 1 implemented by a buck converter or a boost converter. However, the disclosure may employ a first converter 1 implemented by a buck-boost converter that has both a step-up function and a step-down function.

An illustrative embodiment exemplifies PWM signals as pulse signals for use in driving a first converter 1 and a second converter 2. However, the disclosure may employ any given form of signals as the pulse signals.

An illustrative embodiment exemplifies a configuration in which a frequency of a first pulse signal (PWM5) equates with that of second pulse signals (PWM1 to PWM4). However, the disclosure may employ a configuration in which the frequency ratio of the first pulse signal to the second pulse signals is set to an integral multiple. In this case, for example, the frequency of PWM5 may be set to 50 kHz, whereas the frequency of PWM1 to PWM4 may be set to 100 kHz. Alternatively, the frequency of PWM5 may be set to 100 kHz, whereas the frequency of PWM1 to PWM4 may be set to 50 kHz.

An illustrative embodiment employs a configuration in which a phase of a PWM5 for use in driving a first converter 1 is shifted relative to PWM1 to PWM4 for use in driving a second converter 2. However, it is obvious that the phase of PWM1 to PWM4 for use in driving the second converter 2 may be shifted relative to the phase of the PWM5 for use in driving the first converter 1.

An illustrative embodiment employs FETs as switching elements Q1 to Q6. However, the disclosure may employ any given types of switching elements, such as transistors or insulated gate bipolar transistors (IGBTs) instead of FETs. Moreover, the disclosure may employ FETs or transistors, for example, instead of the diodes D1 to D4 in FIGS. 1 and 5.

An illustrative embodiment exemplifies the DC power supply 4 as a power supply; however, the disclosure is not limited to this example. Alternatively, for example, the disclosure may employ an AC power supply as a power supply and may further include a rectifier circuit provided between this AC power supply and a DC-DC converter to full-wave rectify the AC voltage. Moreover, an illustrative embodiment employs electric equipment mounted in a vehicle as a load 5; however, the disclosure may employ any other type of load.

An illustrative second embodiment exemplifies a DC-DC converter mounted in a vehicle as a switching power supply device. However, the disclosure is not limited to this example. Alternatively, the disclosure may also be applied to DC-DC converters to be used in apparatuses other than vehicles. The disclosure is applicable to DC-DC converters as well as AC-DC converters, DC-AC converters, and other types of switching power supply devices.

While the invention has been described with reference to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A switching power supply device that converts an input voltage into a predetermined voltage and then supplies the converted voltage to a load, the switching power supply device being provided between a power supply and the load, the switching power supply device comprising:
a first converter that includes a first switching element configured to switch the input voltage;
a second converter that includes a second switching element and a transformer having a primary side through which a current switched by the second switching element flows, the second converter being provided in a next stage of the first converter; and
a controller configured to generate and output a first pulse signal for use in driving the first switching element and a second pulse signal for use in driving the second switching element,
wherein the controller is configured to shift a phase of the first pulse signal from a phase of the second pulse signal by a predetermined amount so that an exciting current that flows through the transformer in response to switching operations of the first switching element and the second switching element becomes zero on average.

2. The switching power supply device according to claim 1,
wherein the second switching element includes four switching element components that constitute a full-bridge circuit,
wherein the four switching element components include two first switching element components that are paired and turned on together and two second switching element components that are paired and turned on together, and
wherein the controller calculates a difference between a first current flowing through the full-bridge circuit over a first period in which the first switching element components are paired and turned on together and a second current flowing over a second period in which the second switching element components are paired and turned on together, and then shifts the phase of the first pulse signal from the phase of the second pulse signal by the predetermined amount so that the calculated difference becomes zero.

3. The switching power supply device according to claim 2, wherein
the controller includes:
a current difference calculator configured to calculate the difference between the first current and the second current;
a phase adjuster configured to adjust the phases of the first pulse signal and the second pulse signal, based on the difference calculated by the current difference calculator; and
a signal generator configured to generate the first pulse signal and the second pulse signal having a predetermined phase difference, based on an output of the phase adjuster.

4. The switching power supply device according to claim 3,
wherein the controller further includes:
a deviation calculator configured to compare an output voltage of the second converter with a target value and to calculate a deviation between the output voltage and the target value; and
a duty adjuster configured to adjust duties of the first pulse signal and the second pulse signal, based on the deviation calculated by the deviation calculator, and
wherein the signal generator generates the first pulse signal and the second pulse signal having the predetermined phase difference and a predetermined duty, based on outputs of the phase adjuster and the duty adjuster.

5. The switching power supply device according to claim 2, wherein
a period over which the first switching element is turned on equally overlaps the first period over which the first switching element components of the second switching element are paired and turned on together and the second period over which the second switching element components of the second switching element are paired and turned on together.

6. The switching power supply device according to claim 5, wherein
the period over which the first switching element is turned on completely contains a third period over which one of the first switching element components that are paired is turned on but the other of the first switching element components is turned off, the third period being a period between the first period and the second period.

7. The switching power supply device according to claim 1,
wherein a frequency of the first pulse signal equates with a frequency of the second pulse signal, or
wherein a frequency ratio of the first pulse signal to the second pulse signal is set to an integral multiple.

8. The switching power supply device according to claim 1,
wherein the first converter is a buck converter, a boost converter, or a buck-boost converter, and
wherein the second converter is a full-bridge type direct current-direct current converter.
